(19) United States
(12) Patent Application Publication
(10) Pub. No.: US 2024/0167506 A1
(43) Pub. Date: May 23, 2024

(54) SYSTEM AND METHOD TO PROTECT A PREFINISHED ROTOR JOURNAL OF A ROTOR DURING A MANUFACTURING PROCESS

(71) Applicant: GM GLOBAL TECHNOLOGY OPERATIONS LLC, Detroit, MI (US)

(72) Inventors: Joseph G. Lovasz, Ortonville, MI (US); Scott A. Hucker, Ortonville, MI (US); Shane E. Bremer, Hope, MI (US)

(73) Assignee: GM GLOBAL TECHNOLOGY OPERATIONS LLC, Detroit, MI (US)

(21) Appl. No.: 17/992,596

(22) Filed: Nov. 22, 2022

(51) Int. Cl. F16C 32/06; B25H 1/10

(52) U.S. Cl. CPC F16C 32/0614; B25H 1/10; F16C 2322/00

(57) ABSTRACT

A system for protecting a prefinished rotor journal of a rotor during a manufacturing process is provided. The system includes a manufacturing fixture. The fixture includes a plurality of supply lines providing a plurality of pressurized flows. The fixture further includes a plurality of static flow bearings configured for suspending the prefinished rotor journal between the plurality of static flow bearings without the prefinished rotor journal contacting the plurality of static flow bearings. Each of the static flow bearings includes a central duct receiving one of the plurality of pressurized flows. The central duct is configured for directing the one of the plurality of pressurized flows at the prefinished rotor journal.

### INTRODUCTION

The disclosure generally relates to a system and method to protect a prefinished rotor journal of a rotor during a manufacturing process.

An electric machine or motor may include a rotor and a stator. The rotor is a component configured to spin at high-speed relative to the stator. The rotor may include one or more rotor journals. A rotor journal interacts with a journal bearing during operation of the electric machine to as the surface upon which the rotor spins. Lubrication may be present between the rotor journal and the journal bearing.

A rotor bearing may be hardened, ground, and polished. Smooth rotation of the rotor within an electric machine is dependent upon a condition of the rotor bearing surface. The rotor bearing surface may be described as a super-controlled surface, meaning that the dimensions and condition of the surface (including characteristics such as curvature and lack of pitting or blemishes) are important to smooth and efficient operation of the electric machine. Blemishes, scratches caused during manufacturing, pitting, frosting, and fluting are examples of damage that may occur to a rotor journal surface and cause vibrations and inefficiency.

### SUMMARY

A system for protecting a prefinished rotor journal of a rotor during a manufacturing process is provided. The system includes a manufacturing fixture. The manufacturing fixture includes a plurality of supply lines providing a plurality of pressurized flows and a plurality of static flow bearings configured for suspending the prefinished rotor journal between the plurality of static flow bearings without the prefinished rotor journal contacting the plurality of static flow bearings. Each of the static flow bearings includes a central duct receiving one of the plurality of pressurized flows, wherein the central duct is configured for directing the one of the plurality of pressurized flows at the prefinished rotor journal.

In some embodiments, the plurality of static flow bearings is arranged in a radial pattern about a center point between the static flow bearings, such that a longitudinal axis of the central duct for each of the static flow bearings is oriented to intersect with the center point.

In some embodiments, the plurality of static flow bearings includes three static flow bearings.

In some embodiments, the manufacturing fixture further includes a moveable feature, a static portion including a first portion of the plurality of static flow bearings, and a moving portion including a remaining portion of the plurality of static flow bearings. The moving portion is configured for moving through actuation of the moveable feature away from the static portion to create an open loading state, wherein the manufacturing fixture is configured for receiving the rotor. The moving portion is configured for moving through actuation of the moveable feature to abut the static portion to create a closed operational state. The manufacturing fixture is configured for suspending the prefinished rotor journal between the static flow bearings.

In some embodiments, the manufacturing fixture further includes a control piston selectively moving the moving portion to selectively create the open loading state and the closed operational state.

In some embodiments, the manufacturing fixture further includes a proximity sensor configured to provide data related to the manufacturing fixture being in the closed operational state.

According to one alternative embodiment, a system for protecting a prefinished rotor journal of a rotor during a manufacturing process is provided. The system includes the rotor including the prefinished rotor journal. The system further includes a manufacturing fixture. The manufacturing fixture includes a plurality of supply lines providing a plurality of pressurized flows and a plurality of static flow bearings configured for suspending the prefinished rotor journal between the plurality of static flow bearings without the prefinished rotor journal contacting the plurality of static flow bearings. Each of the static flow bearings includes a central duct receiving one of the plurality of pressurized flows, wherein the central duct is configured for directing the one of the plurality of pressurized flows at the prefinished rotor journal.

In some embodiments, the plurality of static flow bearings is arranged in a radial pattern about a center point between the static flow bearings, such that a longitudinal axis of the central duct for each of the static flow bearings is oriented to intersect with the center point.

In some embodiments, the plurality of static flow bearings includes three static flow bearings.

In some embodiments, the manufacturing fixture further includes a moveable feature, a static portion including a first portion of the plurality of static flow bearings, and a moving portion including a remaining portion of the plurality of static flow bearings. The moving portion is configured for moving through actuation of the moveable feature away from the static portion to create an open loading state. The manufacturing fixture is configured for receiving the rotor. The moving portion is configured for moving through actuation of the moveable feature to abut the static portion to create a closed operational state, wherein the manufacturing fixture is configured for suspending the prefinished rotor journal between the static flow bearings.

In some embodiments, the manufacturing fixture further includes a control piston selectively moving the moving portion to selectively create the open loading state and the closed operational state.

In some embodiments, the manufacturing fixture further includes a proximity sensor configured to provide data related to the manufacturing fixture being in the closed operational state.

According to one alternative embodiment, a method to protect a prefinished rotor journal of a rotor during a manufacturing process is provided. The method includes, within a manufacturing fixture, providing a plurality of pressurized flows through a plurality of supply lines and directing the plurality of pressurized flows through a plurality of static flow bearings configured for suspending the prefinished rotor journal between the plurality of static flow bearings without the prefinished rotor journal contacting the plurality of static flow bearings. The method further includes disposing the prefinished rotor journal of the rotor between the plurality of static flow bearings and suspending the prefinished rotor journal between the plurality of static flow bearings.

In some embodiments, directing the plurality of pressurized flows through the plurality of static flow bearings includes arranging the plurality of static flow bearings in a radial pattern about a center point between the static flow bearings, such that a longitudinal axis of the central duct for each of the static flow bearings is oriented to intersect with the center point.

In some embodiments, directing the plurality of pressurized flows through the plurality of static flow bearings includes directing the plurality of pressurized flows through three static flow bearings.

In some embodiments, the method further includes selectively transitioning the manufacturing fixture into an open loading state, wherein a moving portion of the manufacturing fixture including a portion of the static flow bearings is moved away from a static portion of the manufacturing fixture to enable the rotor to be loaded into the manufacturing fixture. The method further includes selectively transitioning the manufacturing fixture into a closed operational state, wherein the prefinished rotor journal is suspended between the static flow bearings.

In some embodiments, the method further includes activating a control piston to move the moving portion to selectively create the open loading state and the closed operational state.

In some embodiments, the method further includes utilizing a proximity sensor to provide data related to the manufacturing fixture being in the closed operational state.

In some embodiments, providing the plurality of pressurized flows includes providing a plurality of flows or pressurized air.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates in cross-sectional side view a system for protecting a prefinished rotor journal during a manufacturing process, in accordance with the present disclosure;

FIG. 2 schematically illustrates in cross-sectional side view the prefinished rotor journal and the static flow bearing of FIG. 1 in magnified scale, in accordance with the present disclosure;

FIG. 3 schematically illustrates an embodiment of the system of FIG. 1 in a front view, in accordance with the present disclosure;

FIG. 4 schematically illustrates the system of FIG. 3 in a front view including the manufacturing fixture in an open loading state, in accordance with the present disclosure; and

FIG. 5 is a flowchart illustrating a method to protect a prefinished rotor journal of the rotor of FIG. 1 during a manufacturing process, in accordance with the present disclosure.

### DETAILED DESCRIPTION

A rotor journal may be a cylindrical surface on a rotor of an electric machine. When installed to an electric machine, the cylindrical surface of the rotor journal matches or interacts with a surface of a journal bearing, wherein the rotor journal spins relative to the surface of the journal bearing, with a layer of lubrication being provided between the surfaces.

A rotor includes a metallic rotor body and a number of features attached to the metallic rotor body. The rotor journal is formed unitarily with and may be described as a portion of the metallic rotor body. During rotor manufacturing, the metallic rotor body may be turned, for example, to install windings of wire upon the metallic rotor body. Handling of the rotor including spinning of the metallic rotor body during manufacturing may be source of scratches and other damage to the rotor journal.

A system and method to protect a prefinished rotor journal during a manufacturing process is provided. The system includes a manufacturing fixture including a plurality of static flow bearings useful to suspend the prefinished rotor journal of a rotor above a portion of the plurality of static flow bearings. The static flow bearings may, in one embodiment, be described as aerostatic air bearings. The plurality of static flow bearings is disposed around the prefinished rotor journal and enable the rotor to spin without the prefinished rotor journal touching the static flow bearings. One of a plurality of static flow bearings may be a moveable feature, to enable the one of the static flow bearings to selectively move between an open loading state and a closed operational state.

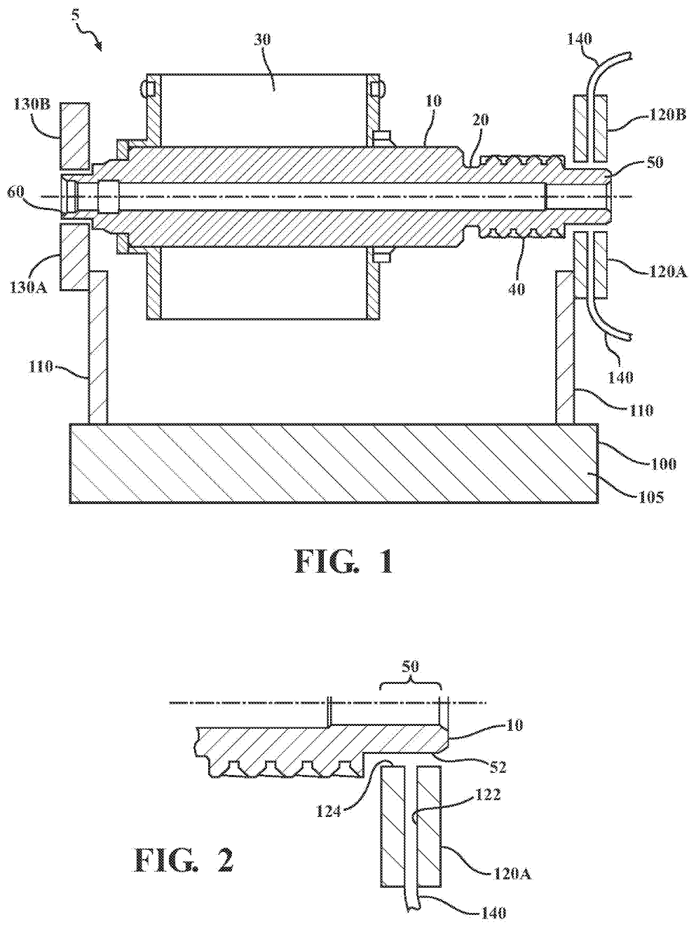

Referring now to the drawings, wherein like reference numbers refer to like features throughout the several views, FIG. 1 schematically illustrates in cross-sectional side view a system 5 for protecting a prefinished rotor journal during a manufacturing process. The system 5 includes a manufacturing fixture 100 and a rotor 10. The rotor 10, when completed, will be useful for installation into an electric machine. The rotor 10 includes a rotor shaft 20, a rotor windings portion 30, a drive gear portion 40, a prefinished rotor journal 50, and a rotor bearing surface 60. The prefinished rotor journal 50 may include a hardened, ground, and polished rotor journal surface. A condition of the rotor journal surface may affect efficiency and lifespan of the electric machine to which the rotor is installed. Within the electric machine, the prefinished rotor journal 50 may be fitted within a journal bearing and may include a layer of lubrication. As the rotor 10 spins within the electric machine, damage, scratches, blemishes, and other defects in the rotor journal surface may cause vibrations, inefficiency, and dissatisfaction with the operation of the electric machine.

The manufacturing fixture 100 is provided for enabling manufacture of the rotor 10 and components thereto and spinning the rotor 10 during the manufacture, while protecting the prefinished rotor journal 50 from damage. The manufacturing fixture 100 is illustrated including a base portion 105, support features 110, static flow bearings 120A, 120B, bearing fixtures 130A, 130B, and supply lines 140. The supply lines 140 provide a plurality of pressurized flows to the static flow bearings 120A, 120B, such that each pressurized flow acts upon or causes forces to act upon the prefinished rotor journal 50 and suspends the prefinished rotor journal 50 between the static flow bearings 120A, 120B. The pressurized flows may each include a flow of air, a flow of gas, such a nitrogen, or a flow of fluid, such as oil. The prefinished rotor journal 50 may spin about a central or longitudinal axis of the shaft 20 without the prefinished rotor journal 50 touching the static flow bearings 120A, 120B. By suspending the prefinished rotor journal 50 while enabling the rotor 10 to spin, manufacturing operations may be performed upon the rotor 10 while protecting the prefinished rotor journal 50 from damaging contact.

In the embodiment of FIG. 1, the rotor bearing surface 60 and the bearing fixtures 130A, 130B may not additionally include a prefinished rotor journal and a plurality of static flow bearings but may rather include a low friction bearing interface such as a ball-bearing interface, a roller-bearing interface, or a bushing interface. In other embodiments, the rotor bearing surface 60 may include a second prefinished rotor journal and the bearing fixtures 130A, 130B may include a second plurality of static flow bearings. The manufacturing fixture 100 may additionally include one or more lateral datums, or features useful to locate the rotor 10 within the manufacturing fixture 100 in a direction of the longitudinal axis of the rotor 10.

FIG. 2 schematically illustrates in cross-sectional side view the prefinished rotor journal 50 and the static flow bearing 120A of FIG. 1 in magnified scale. The rotor 10 is illustrated including the prefinished rotor journal 50 including a rotor journal surface 52. The static flow bearing 120A is illustrated including a central duct 122 and a rotor journal mating surface 124. The supply line 140 is illustrated attached to the central duct 122, such that a pressurized flow may be channeled through the central duct 122. The central duct 122 may be a cylinder shape, and a longitudinal axis of the central duct 122 may be defined as a longitudinal axis of the cylinder shape. Upon exiting the central duct 122, the pressurized flow comes into contact with the rotor journal surface 52 and results in a force acting thereupon. The force acting upon the rotor journal surface 52 causes the rotor 10 to be suspended above the rotor journal mating surface 124 of the static flow bearing 120A. The rotor 10 may rotate or spin about a longitudinal axis of the rotor 10 while remaining suspended over the static flow bearing 120A. Positioned between the static flow bearing 120A and at least one other static flow bearing, including the static flow bearing 120B of FIG. 1, the prefinished rotor journal 50 may be utilized to fixture or suspend the rotor 10 within the manufacture fixture 100 without damaging contact occurring to the prefinished rotor journal 50. In this way, manufacturing operations may be performed upon the rotor 10 while protecting the prefinished rotor journal 50. A longitudinal axis of the rotor 10 may intersect with a center point located between the static flow bearings 120A, 120B.

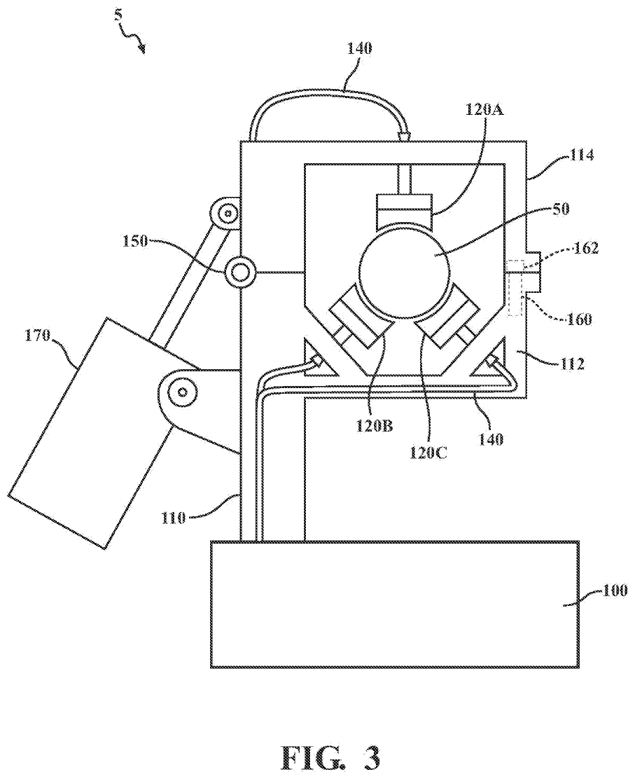

FIG. 3 schematically illustrates an embodiment of the system 5 of FIG. 1 in a front view. The manufacturing fixture 100 is illustrated including the support features 110, static flow bearings 120A, 120B, 120C, and supply lines 140. The static flow bearings 120A, 120B, 120C may be fixed, unmoving features of the manufacturing fixture 100, for example, with the prefinished rotor journal being moved longitudinally along the longitudinal axis of the rotor 10 of FIG. 1 to fit between the static flow bearings 120A, 120B, 120C. The static flow bearings 120A, 120B, 120C are arranged in a radial pattern about a center point between the static flow bearings 120A, 120B, 120C, such that longitudinal axes of the central ducts 122 of FIG. 2 for each of the static flow bearings 120A, 120B, 120C are oriented to intersect with the center point between the static flow bearings 120A, 120B, 120C. In the embodiment of FIG. 3, the manufacturing fixture 100 includes a moveable feature 150 enabling a moving portion 114 of the manufacturing fixture 100 to move away from a fixed portion 112 of the manufacturing fixture 100. The moveable feature 150 may include a hinge, or the moveable feature 150 may include clamping features, sliding features, or other similar features that enable a portion of the manufacturing fixture 100 to translate between locations. The static flow bearings 120B, 120C are attached to the fixed portion 112, while the static flow bearing 120A is attached to the moving portion 114. A control piston 170 is provided attached to the moving portion 114, such that activation of the control piston 170 may cause the manufacturing fixture 100 to transition between an open loading state and a closed operational state. The open loading state permits the rotor 10 to be loaded into or removed from the manufacturing fixture 100. The closed operational state results in the prefinished rotor journal being suspended between the static flow bearings 120A, 120B, 120C and free to spin about a longitudinal axis of the rotor 10. In FIG. 3, the manufacturing fixture 100 is illustrated in the closed operational state, such that the prefinished rotor journal 50 is located between the static flow bearing 120A, the static flow bearing 120B, and the static flow bearing 120C.

The static flow bearings 120A, 120B, 120C are illustrated in FIG. 3 as being disposed at approximately equidistant locations around the circumference of the prefinished rotor journal 50. Each of the static flow bearings 120A, 120B, 120C may utilized a pressurized flow to create a force acting toward a center of the shaft 20 of FIG. 1. A sum of the forces acting upon the prefinished rotor journal 50, including the forces provided by the static flow bearings 120A, 120B, 120C and a force of the weight of the rotor 10, may equal zero, such that the rotor 10 may be suspended between the static flow bearings 120A, 120B, 120C without contacting the static flow bearings 120A, 120B, 120C. In another embodiment, two static flow bearings may be utilized to suspend the rotor 10, for example, with a curved rotor journal mating surface of the static flow bearings and/or a plurality of central ducts upon each of the static flow bearings enabling the rotor to be suspended between the two static flow bearings. In another example, more than three static flow bearings may be utilized to suspend the rotor 10.

The manufacturing fixture 100 may include a proximity sensor 160 and a mating sensor feature 162 configured for enabling a computerized control unit to determine that the manufacturing fixture is in the closed operational state.

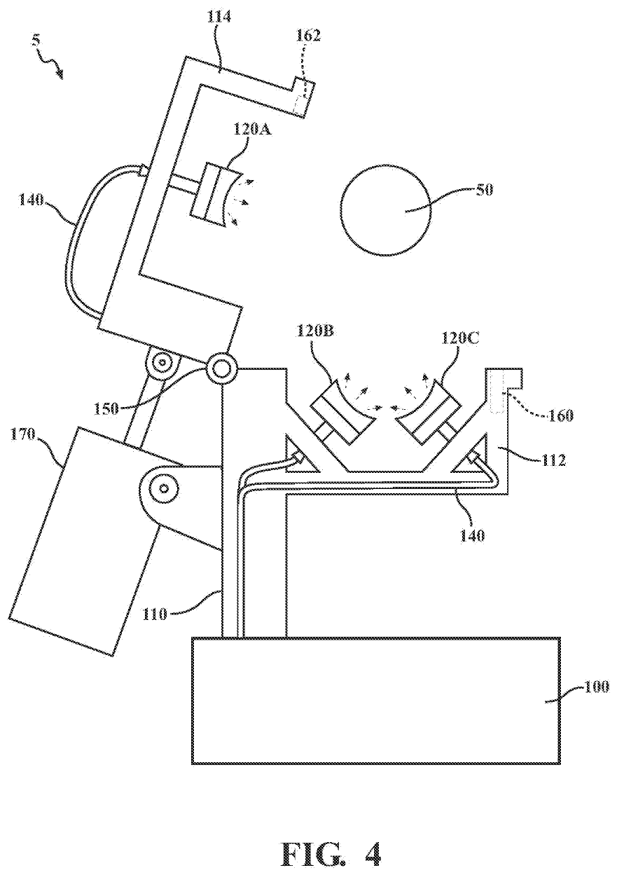

FIG. 4 schematically illustrates the system 5 of FIG. 3 in a front view including the manufacturing fixture 100 in an open loading state. The manufacturing fixture 100 is illustrated including the support feature 110, the fixed portion 112, the moving portion 114, the static flow bearings 120A, 120B, 120C, the moveable feature 150, and the control piston 170. The proximity sensor 160 is illustrated affixed to the fixed portion 112, and the mating sensor feature 162 is illustrated affixed to the moving portion 114. The supply line 140 are illustrated connected to the static flow bearings 120A, 120B, 120C. The moving portion 114 is illustrated moved about moveable feature 150 away from the fixed portion 112. As a result, the rotor 10 of FIG. 1 including the illustrated prefinished rotor journal 50 may be either loaded into the manufacturing fixture 100 or removed from the manufacturing fixture 100.

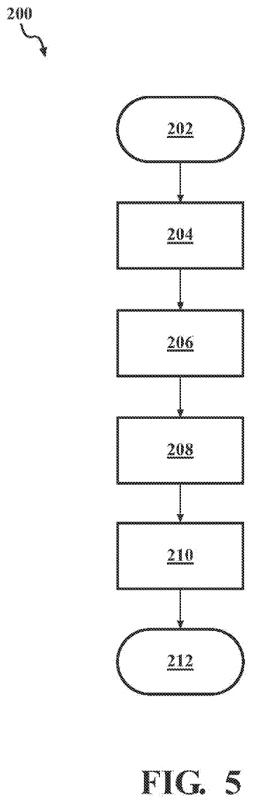

FIG. 5 is a flowchart illustrating a method 200 to protect a prefinished rotor journal 50 of the rotor 10 of FIG. 1 during a manufacturing process. The method 200 is described in relation to the manufacturing fixture 100 of FIGS. 1-4, although the method 200 may be utilized in combination with alternative embodiments of the manufacturing fixture 100. The method 200 starts at step 202. At step 204, the manufacturing fixture 100 starts in an open loading state, with the moving portion 114 moved about the moveable feature 150 away from the fixed portion. At step 206, the rotor 10 is loaded into the manufacturing fixture 100, the moving portion 114 is moved to abut the fixed portion 112, and the prefinished rotor journal 50 of the rotor 10 is suspended between the static flow bearings 120A, 120B, 120C of the manufacturing fixture 100. At step 208, manufacturing processes are operated upon the rotor 10, for example, with wire windings being created upon the rotor 10, as the rotor 10 is enabled to spin about a longitudinal axis of the rotor 10 without the prefinished rotor journal making contact with the static flow bearings 120A, 120B, 120C. At step 210, as the manufacturing processes are completed, the manufacturing fixture 100 is transitioned back to the open loading state, and the rotor 10 is removed from the manufacturing fixture 100. The method 200 ends at step 212. The method 200 is exemplary. A number of additional and/or alternative method steps are envisioned, and the disclosure is not intended to be limited to the examples provided herein.

While the best modes for carrying out the disclosure have been described in detail, those familiar with the art to which this disclosure relates will recognize various alternative designs and embodiments for practicing the disclosure within the scope of the appended claims.

What is claimed is:

1. A system for protecting a prefinished rotor journal of a rotor during a manufacturing process, the system comprising:
a manufacturing fixture including:
a plurality of supply lines providing a plurality of pressurized flows; and
a plurality of static flow bearings configured for suspending the prefinished rotor journal between the plurality of static flow bearings without the prefinished rotor journal contacting the plurality of static flow bearings; and
wherein each of the static flow bearings includes a central duct receiving one of the plurality of pressurized flows, wherein the central duct is configured for directing the one of the plurality of pressurized flows at the prefinished rotor journal.

2. The system of claim 1, wherein the plurality of static flow bearings is arranged in a radial pattern about a center point between the static flow bearings, such that a longitudinal axis of the central duct for each of the static flow bearings is oriented to intersect with the center point.

3. The system of claim 1, wherein the plurality of static flow bearings includes three static flow bearings.

4. The system of claim 1, wherein the manufacturing fixture further includes:
a moveable feature;
a static portion including a first portion of the plurality of static flow bearings; and
a moving portion including a remaining portion of the plurality of static flow bearings; and
wherein the moving portion is configured for moving through actuation of the moveable feature away from the static portion to create an open loading state, wherein the manufacturing fixture is configured for receiving the rotor; and
wherein the moving portion is configured for moving through actuation of the moveable feature to abut the static portion to create a closed operational state, wherein the manufacturing fixture is configured for suspending the prefinished rotor journal between the static flow bearings.

5. The system of claim 4, wherein the manufacturing fixture further includes a control piston selectively moving the moving portion to selectively create the open loading state and the closed operational state.

6. The system of claim 4, wherein the manufacturing fixture further includes a proximity sensor configured to provide data related to the manufacturing fixture being in the closed operational state.

7. A system for protecting a prefinished rotor journal of a rotor during a manufacturing process, the system comprising:
the rotor including the prefinished rotor journal; and
a manufacturing fixture including:
a plurality of supply lines providing a plurality of pressurized flows; and
a plurality of static flow bearings configured for suspending the prefinished rotor journal between the plurality of static flow bearings without the prefinished rotor journal contacting the plurality of static flow bearings; and
wherein each of the static flow bearings includes a central duct receiving one of the plurality of pressurized flows, wherein the central duct is configured for directing the one of the plurality of pressurized flows at the prefinished rotor journal.

8. The system of claim 7, wherein the plurality of static flow bearings is arranged in a radial pattern about a center point between the static flow bearings, such that a longitudinal axis of the central duct for each of the static flow bearings is oriented to intersect with the center point.

9. The system of claim 7, wherein the plurality of static flow bearings includes three static flow bearings.

10. The system of claim 7, wherein the manufacturing fixture further includes:
a moveable feature;
a static portion including a first portion of the plurality of static flow bearings; and
a moving portion including a remaining portion of the plurality of static flow bearings; and
wherein the moving portion is configured for moving through actuation of the moveable feature away from the static portion to create an open loading state, wherein the manufacturing fixture is configured for receiving the rotor; and
wherein the moving portion is configured for moving through actuation of the moveable feature to abut the static portion to create a closed operational state, wherein the manufacturing fixture is configured for suspending the prefinished rotor journal between the static flow bearings.

11. The system of claim 10, wherein the manufacturing fixture further includes a control piston selectively moving the moving portion to selectively create the open loading state and the closed operational state.

12. The system of claim 10, wherein the manufacturing fixture further includes a proximity sensor configured to provide data related to the manufacturing fixture being in the closed operational state.

13. A method to protect a prefinished rotor journal of a rotor during a manufacturing process, the method comprising:
within a manufacturing fixture, providing a plurality of pressurized flows through a plurality of supply lines;
directing the plurality of pressurized flows through a plurality of static flow bearings configured for suspending the prefinished rotor journal between the plurality of static flow bearings without the prefinished rotor journal contacting the plurality of static flow bearings;
disposing the prefinished rotor journal of the rotor between the plurality of static flow bearings; and
suspending the prefinished rotor journal between the plurality of static flow bearings.

14. The method of claim 13, wherein directing the plurality of pressurized flows through the plurality of static flow bearings includes arranging the plurality of static flow bearings in a radial pattern about a center point between the static flow bearings, such that a longitudinal axis of the central duct for each of the static flow bearings is oriented to intersect with the center point.

15. The method of claim 13, wherein directing the plurality of pressurized flows through the plurality of static flow bearings includes directing the plurality of pressurized flows through three static flow bearings.

16. The method of claim 13, further comprising:
selectively transitioning the manufacturing fixture into an open loading state, wherein a moving portion of the manufacturing fixture including a portion of the static flow bearings is moved away from a static portion of the manufacturing fixture to enable the rotor to be loaded into the manufacturing fixture; and
selectively transitioning the manufacturing fixture into a closed operational state, wherein the prefinished rotor journal is suspended between the static flow bearings.

17. The method of claim 16, further comprising activating a control piston to move the moving portion to selectively create the open loading state and the closed operational state.

18. The method of claim 16, further comprising utilizing a proximity sensor to provide data related to the manufacturing fixture being in the closed operational state.

19. The method of claim 13, wherein providing the plurality of pressurized flows includes providing a plurality of flows or pressurized air.
